(19) United States
(12) Patent Application Publication
(10) Pub. No.: US 2026/0210499 A1
(43) Pub. Date: Jul. 23, 2026

(54) LIQUEFIED-GAS DELIVERY SYSTEM

(71) Applicant: EBARA CORPORATION, Tokyo (JP)

(72) Inventors: Hoechun KIM, Tokyo (JP); Hiromasa MIYATA, Tokyo (JP); Hiroyuki KAWASAKI, Tokyo (JP); Tetsuji KASATANI, Tokyo (JP); Shuichiro HONDA, Tokyo (JP)

(21) Appl. No.: 19/136,571

(22) PCT Filed: Dec. 16, 2022
(86) PCT No.: PCT/JP2022/046440

§ 371 Date: Jun. 6, 2025

(51) Int. Cl. F17C 13/04

(52) U.S. Cl. CPC F17C 13/04; F17C 2205/0335; F17C 2223/0153; F17C 2227/0142; F17C 2227/0337

(57) ABSTRACT

The liquefied-gas delivery system includes a reciprocating pump apparatus (3) for pressurizing liquefied gas and boil-off gas in a storage tank (1). The reciprocating pump apparatus (3) includes a cylinder (14) having a gas pressurization chamber (10) and a liquid pressurization chamber (11) therein, a piston (17) disposed in the cylinder (14), and an actuator (18) coupled to the piston (17) for reciprocating the piston (17). The piston (17) is located between the gas pressurization chamber (10) and the liquid pressurization chamber (11). The piston (17) has a gas pressurization surface (21) facing the gas pressurization chamber (10) and a liquid pressurization surface (22) facing the liquid pressurization chamber (11).

### TECHNICAL FIELD

The present invention relates to a liquefied-gas delivery system for delivering liquefied gas, such as liquefied natural gas (LNG) or liquid hydrogen, stored in a storage tank, and in particular to a liquefied-gas delivery system including a pump apparatus for pumping the liquefied gas and boil-off gas.

### BACKGROUND ART

Natural gas is widely used for thermal power generation and is used as a chemical raw material. Hydrogen is also expected to serve as an energy source that does not generate carbon dioxide, which causes global warming. Applications of hydrogen as an energy source include fuel cell and turbine power generation. Natural gas and hydrogen are in a gaseous state at room temperature, and therefore they are cooled and liquefied for storage and transportation. Liquefied gases, such as liquefied natural gas (LNG) and liquid hydrogen, are delivered to power plants, hydrogen stations, and the like by transport vehicles.

There are two types of hydrogen stations. One type is configured to vaporize stored liquid hydrogen and pressurize the hydrogen with a compressor to supply the hydrogen to fuel cell vehicles, etc. The other type is configured to pressurize stored liquid hydrogen with a pump, then vaporize the liquid hydrogen and supply the hydrogen to fuel cell vehicles, etc. The latter can boost the pressure of larger amounts of hydrogen than the former, and therefore the overall equipment configuration of the hydrogen station can be reduced.

FIG. 10 is a schematic diagram showing an example of a hydrogen station. Liquid hydrogen is transported to the hydrogen station by a transport vehicle (not shown) and stored in a storage tank 200. A pump 201 sends the liquid hydrogen from the storage tank 200 to an evaporator 202, which makes the liquid hydrogen into hydrogen gas. The hydrogen gas is sent to a pressure accumulator 203, and the high-pressure hydrogen gas is held in the pressure accumulator 203. The hydrogen gas is further sent to a dispenser 204 and is supplied from the dispenser 204 to a fuel cell vehicle or the like.

### CITATION LIST

### Patent Literature

Patent document 1: Japanese laid-open patent publication No. 2008-196590

### SUMMARY OF INVENTION

### Technical Problem

However, in the hydrogen station, vaporized hydrogen (i.e., boil-off gas: BOG) is generated due to heat input from outside to a pipe system and the storage tank 200, and due to heat generated by the operation of the pump 201. Since the boil-off gas has almost atmospheric pressure, it is difficult to reuse the boil-off gas in the hydrogen station, and it is usually discarded into the air. There are methods for reusing the generated boil-off gas, such as a method of recovering and using the boil-off gas in a fuel cell, and a method of compressing the boil-off gas with a compressor and storing it in a system. However, both of these methods require expensive capital investment and entail an increased installation area for the system. Such problems can occur not only with the liquid hydrogen, but also with other types of liquefied gas, such as liquefied natural gas.

Therefore, the present invention provides a liquefied-gas delivery system that can effectively utilize boil-off gas generated from liquefied gas with a simple configuration.

### Solution to Problem

In an embodiment, there is provided a liquefied-gas delivery system for delivering liquefied gas in a storage tank, comprising: a reciprocating pump apparatus configured to pressurize the liquefied gas and boil-off gas in the storage tank, the reciprocating pump apparatus including: a cylinder having a gas pressurization chamber and a liquid pressurization chamber therein; a piston disposed in the cylinder; and an actuator coupled to the piston and configured to reciprocate the piston, wherein the piston is located between the gas pressurization chamber and the liquid pressurization chamber, and the piston has a gas pressurization surface facing the gas pressurization chamber and a liquid pressurization surface facing the liquid pressurization chamber.

In an embodiment, the piston comprises a gas pressurizing piston having the gas pressurizing surface, and a liquid pressurizing piston having the liquid pressurizing surface, the reciprocating pump apparatus further comprises: a coupling member that couples the gas pressurizing piston to the liquid pressurizing piston and allows the gas pressurizing piston and the liquid pressurizing piston to reciprocate together; and an intermediate chamber located between the gas pressurizing piston and the liquid pressurizing piston and is located within the cylinder.

In an embodiment, the reciprocating pump apparatus further comprises: a communication flow passage that provides a fluid communication between the intermediate chamber and the gas pressurization chamber; and a check valve disposed in the communication flow passage, the check valve being configured to allow a one-way flow from the intermediate chamber to the gas pressurization chamber.

In an embodiment, the cylinder has a boil-off gas inlet communicating with the intermediate chamber.

In an embodiment, the communication flow passage extends through the gas pressurizing piston.

In an embodiment, the communication flow passage is disposed outside the cylinder.

In an embodiment, the cylinder has a boil-off gas inlet communicating with the gas pressurizing chamber.

In an embodiment, at least a part of the actuator is disposed within the cylinder.

In an embodiment, a position at which the actuator is coupled to the piston is located within the cylinder.

In an embodiment, the reciprocating pump apparatus further comprises a relief valve communicating with the intermediate chamber.

In an embodiment, the liquefied-gas delivery system further comprises: a first discharge line coupled to the gas pressurization chamber; a second discharge line coupled to the liquid pressurization chamber; and a cooling device coupled to the first discharge line.

In an embodiment, the cooling device is a heat exchanger having a heating flow path and a cooling flow path adjacent to each other, the heating flow path being coupled to the first discharge line, and the cooling flow path being coupled to the second discharge line.

In an embodiment, the liquefied-gas delivery system further comprises a pressure-reducing device coupled to the first discharge line and disposed downstream of the cooling device.

In an embodiment, the liquefied-gas delivery system further comprises a return line extending from the pressure-reducing device to the storage tank.

### Advantageous Effects of Invention

According to the present invention, the piston disposed in the cylinder can alternately pressurize the liquefied gas and the boil-off gas. Therefore, there is no need to provide a dedicated compressor for pressurizing the boil-off gas, and the installation area is not increased. The boil-off gas is pressurized by the piston to form a supercritical fluid. The supercritical fluid can be reused by being cooled. Furthermore, when the cooled supercritical fluid is depressurized, the supercritical fluid becomes a gas-liquid mixture, so that the liquefied gas can be recovered from the gas-liquid mixture.

### BRIEF DESCRIPTION OF DRAWINGS

FIG. 1 is a schematic diagram showing one embodiment of a liquefied-gas delivery system;

FIG. 2 is a Mollier diagram showing a state of hydrogen circulating in the liquefied-gas delivery system;

FIG. 3 is a schematic diagram showing another embodiment of the liquefied-gas delivery system;

FIG. 4 is a schematic diagram showing yet another embodiment of the liquefied-gas delivery system;

FIG. 5 is a schematic diagram showing another embodiment of a reciprocating pump apparatus;

FIG. 6 is a schematic diagram showing yet another embodiment of the reciprocating pump apparatus;

FIG. 7 is a schematic diagram showing yet another embodiment of the reciprocating pump apparatus;

FIG. 8 is a schematic diagram showing yet another embodiment of the reciprocating pump apparatus;

FIG. 9 is a schematic diagram showing yet another embodiment of the reciprocating pump apparatus; and

FIG. 10 is a schematic diagram showing an example of a hydrogen station.

### DESCRIPTION OF EMBODIMENTS

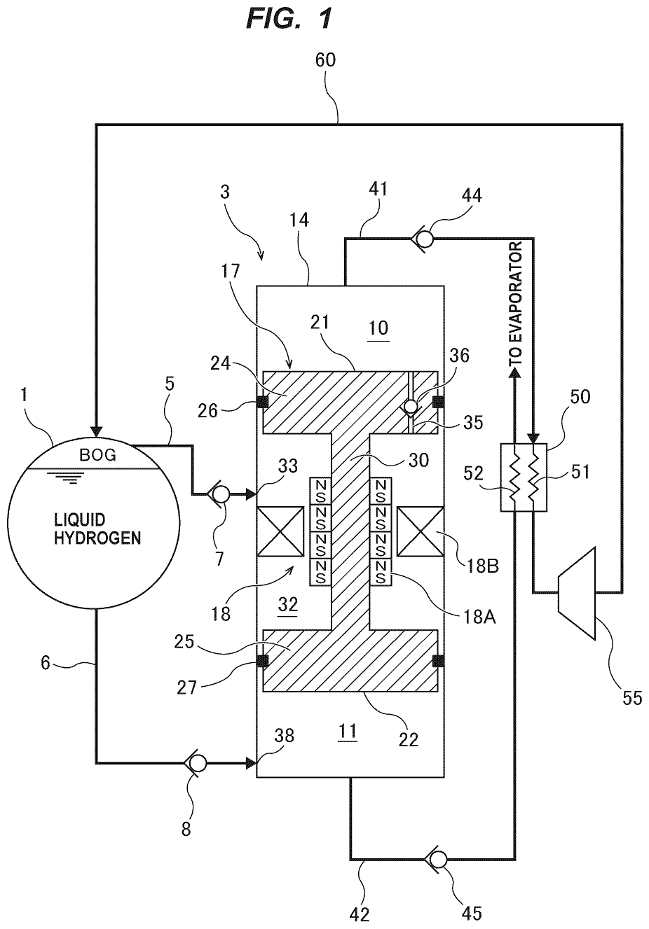

Hereinafter, embodiments of the present invention will be described with reference to the drawings. FIG. 1 is a schematic diagram showing an embodiment of a liquefied-gas delivery system. The liquefied-gas delivery system of the embodiment shown in FIG. 1 is a system for delivering liquid hydrogen as an example of liquefied gas. The present invention is not limited to a delivery system for liquid hydrogen, and can be applied to delivery systems for other types of liquefied gas, such as liquefied natural gas (LNG), liquefied ammonia, liquid nitrogen, liquefied ethylene gas, and liquefied petroleum gas. The liquid hydrogen is stored in a storage tank 1. Most of the hydrogen in the storage tank 1 is liquid, but a small amount of heat from the surrounding atmosphere is delivered to the liquid hydrogen through a wall of the storage tank 1. As a result, a part of the liquid hydrogen is gasified to form boil-off gas (BOG). Therefore, as shown in FIG. 1, liquefied gas (liquid hydrogen) and boil-off gas (hydrogen gas) exist in the storage tank 1.

The liquefied-gas delivery system includes a reciprocating pump apparatus 3 configured to suck in both the boil-off gas and the liquid hydrogen present in the storage tank 1 and pressurize them separately, and a gas delivery line 5 and a liquid delivery line 6 configured to couple the reciprocating pump apparatus 3 to the storage tank 1. The boil-off gas (BOG) in the storage tank 1 is delivered to the reciprocating pump apparatus 3 through the gas delivery line 5, and the liquid hydrogen in the storage tank 1 is delivered to the reciprocating pump apparatus 3 through the liquid delivery line 6. A gas check valve 7 and a liquid check valve 8 are attached to the gas delivery line 5 and the liquid delivery line 6, respectively. These check valves 7 and 8 are configured to allow only one-way flow from the storage tank 1 to the reciprocating pump apparatus 3.

The reciprocating pump apparatus 3 includes a cylinder 14 having a gas pressurizing chamber 10 and a liquid pressurizing chamber 11 therein, a piston 17 disposed in the cylinder 14, and an actuator 18 coupled to the piston 17 for reciprocating the piston 17 within the cylinder 14. The piston 17 is located between the gas pressurizing chamber 10 and the liquid pressurizing chamber 11. The entire actuator 18 is disposed within the cylinder 14. Therefore, no piston rod is provided extending from the piston 17 to the outside of the cylinder 14. The actuator 18 in this embodiment is a linear motor including permanent magnets 18A and coils 18B, but the specific configuration of the actuator 18 is not limited to this embodiment. For example, the actuator 18 may be a hydraulic cylinder, or a combination of a crank mechanism and an electric motor.

The cylinder 14 is a hermetic container and is configured not to allow leakage of the hydrogen that has been introduced therein. The entire piston 17 is located within the cylinder 14. The piston 17 has a gas pressurizing surface 21 facing the gas pressurizing chamber 10 and a liquid pressurizing surface 22 facing the liquid pressurizing chamber 11. More specifically, the piston 17 includes a gas pressurizing piston 24 having the gas pressurizing surface 21, and further includes a liquid pressurizing piston 25 having the liquid pressurizing surface 22. The gas pressurizing piston 24 and the liquid pressurizing piston 25 are coupled by a coupling member 30, so that the gas pressurizing piston 24 and the liquid pressurizing piston 25 can reciprocate together.

The reciprocating pump apparatus 3 includes seals attached to a side surface of the piston 17. More specifically, a first seal 26 is attached to a side surface of the gas pressurizing piston 24, and a second seal 27 is attached to a side surface of the liquid pressurizing piston 25. The first seal 26 has a function of sealing a gap between the side surface of the gas pressurizing piston 24 and an inner surface of the cylinder 14, and the second seal 27 has a function of sealing a gap between the side surface of the liquid pressurizing piston 25 and an inner surface of the cylinder 14.

The reciprocating pump apparatus 3 has an intermediate chamber 32 located in the cylinder 14. The intermediate chamber 32 is located between the gas pressurizing piston 24 and the liquid pressurizing piston 25, and reciprocates together with the gas pressurizing piston 24 and the liquid pressurizing piston 25. The intermediate chamber 32 is located between the gas pressurizing chamber 10 and the liquid pressurizing chamber 11. The cylinder 14 has a boil-off gas inlet 33 communicating with the intermediate chamber 32. The boil-off gas inlet 33 is formed in a wall of the cylinder 14 that forms the intermediate chamber 32. The gas delivery line 5 communicates with the intermediate chamber 32 through the boil-off gas inlet 33. Specifically, one end of the gas delivery line 5 is coupled to the top of the storage tank 1, and other end of the gas delivery line 5 is coupled to the boil-off gas inlet 33 of the cylinder 14 and communicates with the intermediate chamber 32.

The entire actuator 18 is disposed within the cylinder 14. More specifically, the entire actuator 18 is disposed within the intermediate chamber 32. The permanent magnets 18A of the actuator 18 are fixed to the coupling member 30 located within the intermediate chamber 32, and the permanent magnets 18A reciprocate together with the coupling member 30 and the piston 17. The coils 18B of the actuator 18 are fixed the inside of the cylinder 14.

The intermediate chamber 32 is located between the gas pressurizing chamber 10 and the liquid pressurizing chamber 11. The reciprocating pump apparatus 3 further includes a communication flow passage 35 that provides a fluid communication between the intermediate chamber 32 and the gas pressurizing chamber 10, and a check valve 36 arranged in the communication flow passage 35. In this embodiment, the communication flow passage 35 is formed in the gas pressurizing piston 24 and extends through the gas pressurizing piston 24. One end of the communication flow passage 35 communicates with the intermediate chamber 32, and the other end of the communication flow passage 35 communicates with the gas pressurizing chamber 10. The check valve 36 is arranged in the gas pressurizing piston 24. The communication flow passage 35 and the check valve 36 reciprocate together with the gas pressurizing piston 24. The check valve 36 is configured to allow only one-way flow from the intermediate chamber 32 to the gas pressurizing chamber 10.

The cylinder 14 has a liquefied-gas inlet 38 that communicates with the liquid pressurizing chamber 11. The liquefied-gas inlet 38 is formed in a wall portion of the cylinder 14 that forms the liquid pressurizing chamber 11. The liquid delivery line 6 communicates with the liquid pressurizing chamber 11 through the liquefied-gas inlet 38. Specifically, one end of the liquid delivery line 6 is coupled to a lower portion of the storage tank 1, and the other end of the liquid delivery line 6 is coupled to the cylinder 14 and communicates with the liquid pressurizing chamber 11.

The liquefied-gas delivery system further includes a first discharge line 41 coupled to the gas pressurization chamber 10, a second discharge line 42 coupled to the liquid pressurization chamber 11, a first discharge-side check valve 44 attached to the first discharge line 41, and a second discharge-side check valve 45 attached to the second discharge line 42. The boil-off gas (hydrogen gas) and the liquid hydrogen pressurized by the reciprocating pump apparatus 3 are discharged through the first discharge line 41 and the second discharge line 42. The first discharge-side check valve 44 and the second discharge-side check valve 45 are configured to allow only a flow in a direction outflowing from the reciprocating pump apparatus 3.

The operation of the reciprocating pump apparatus 3 will be described below. When the piston 17 including the gas pressurizing piston 24 and the liquid pressurizing piston 25 moves within the cylinder 14, the boil-off gas (hydrogen gas) and the liquid hydrogen in the storage tank 1 are introduced into the intermediate chamber 32 and the liquid pressurizing chamber 11 through the gas delivery line 5 and the liquid delivery line 6, respectively. More specifically, when the piston 17 moves downward in FIG. 1, negative pressure is formed in the gas pressurizing chamber 10, and the fluid in the intermediate chamber 32 moves to the gas pressurizing chamber 10 through the communication flow passage 35. As a result, the boil-off gas in the storage tank 1 is introduced into the intermediate chamber 32 through the gas delivery line 5.

When the piston 17 moves upward in FIG. 1, the liquid hydrogen in the storage tank 1 is introduced into the liquid pressurization chamber 11 through the liquid delivery line 6. When the piston 17 then moves downward in FIG. 1, the boil-off gas in the intermediate chamber 32 moves into the gas pressurization chamber 10 through the communication flow passage 35, and the boil-off gas in the storage tank 1 is introduced into the intermediate chamber 32 through the gas delivery line 5. At the same time, the liquid hydrogen in the liquid pressurization chamber 11 is pressurized by the liquid pressurizing piston 25. Furthermore, when the piston 17 moves upward in FIG. 1, the boil-off gas in the gas pressurization chamber 10 is pressurized by the gas pressurizing piston 24, while the liquid hydrogen in the storage tank 1 is introduced into the liquid pressurization chamber 11 through the liquid delivery line 6.

In this way, as the piston 17 reciprocates, the boil-off gas and the liquid hydrogen are alternately pressurized by the piston 17 and alternately discharged from the cylinder 14. The pressure in the gas pressurizing chamber 10 fluctuates greatly as the piston 17 reciprocates, but the pressure in the intermediate chamber 32 is maintained by a set pressure of the check valve 36. As a result, the pressure in the storage tank 1 communicating with the intermediate chamber 32 can be adjusted.

When the liquid pressurizing piston 25 pressurizes the liquid hydrogen in the liquid pressurizing chamber 11, a part of the liquid hydrogen in contact with the second seal 27 is gasified to become boil-off gas, which flows into the intermediate chamber 32. This boil-off gas is mixed with the boil-off gas introduced from the storage tank 1 in the intermediate chamber 32, and flows into the gas pressurizing chamber 10 through the communication flow passage 35. In this way, the boil-off gas generated in the cylinder 14 does not leak from the cylinder 14 to the outside, and the boil-off gas can be recovered.

In particular, the entire actuator 18 is disposed inside the cylinder 14, and the position where the actuator 18 is coupled to the piston 17 is inside the cylinder 14. Therefore, a piston rod penetrating the cylinder 14 is not required, and a seal for sealing a gap between the piston rod and the cylinder 14 is also not required. Furthermore, the boil-off gas does not leak from the gap between the piston rod and the cylinder 14.

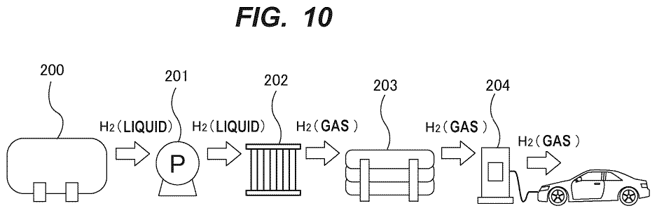

The liquefied-gas delivery system further includes a heat exchanger 50 as a cooling device coupled to the first discharge line 41 and the second discharge line 42. The boil-off gas and the liquid hydrogen pressurized by the reciprocating pump apparatus 3 are sent to the heat exchanger 50 through the first discharge line 41 and the second discharge line 42. The heat exchanger 50 has a heating flow path 51 and a cooling flow path 52 adjacent to each other. The heating flow path 51 is coupled to the first discharge line 41, and the cooling flow path 52 is coupled to the second discharge line 42. In the heat exchanger 50, the pressurized boil-off gas flows through the heating flow path 51, while the pressurized liquid hydrogen flows through the cooling flow path 52. Heat exchange is performed between the pressurized boil-off gas in the heating flow path 51 and the pressurized liquid hydrogen in the cooling flow path 52, and as a result, the pressurized boil-off gas is cooled and the liquid hydrogen is heated. The heated liquid hydrogen may be sent to an evaporator (for example, the evaporator 202 shown in FIG. 10) or the like.

In the present embodiment, the heat exchanger 50 is provided as the cooling device for cooling the pressurized boil-off gas, but the type of the cooling device is not particularly limited as long as the cooling device can cool the pressurized boil-off gas. For example, a refrigerator in which a refrigerant circulates may be used as the cooling device.

The liquefied-gas delivery system further includes a pressure-reducing device 55 coupled to the first discharge line 41. The pressure-reducing device 55 is disposed downstream of the heat exchanger 50 serving as the cooling device. The pressure-reducing device 55 is a device for reducing the pressure of the pressurized and cooled boil-off gas that has passed through the heat exchanger 50 serving as the cooling device to the atmospheric pressure. Specific configuration of the pressure-reducing device 55 is not particularly limited as long as the pressure-reducing device 55 can perform its intended function. For example, examples of the pressure-reducing device 55 include an expander and a Joule-Thomson valve.

The liquefied-gas delivery system further includes a return line 60 extending from the pressure-reducing device 55 to the top of the storage tank 1. When the pressure of the pressurized and cooled boil-off gas is reduced to the atmospheric pressure by the pressure-reducing device 55, the boil-off gas becomes a gas-liquid mixture. This gas-liquid mixture is returned to the storage tank 1 through the return line 60. Liquid hydrogen (liquefied gas) contained in the gas-liquid mixture is mixed with the liquid hydrogen held in the storage tank 1. Hydrogen gas contained in the gas-liquid mixture is mixed with the boil-off gas (hydrogen gas) held in the storage tank 1.

In this way, a part of the boil-off gas sent from the storage tank 1 to the reciprocating pump apparatus 3 forms the liquid hydrogen (liquefied gas) and is recovered in the storage tank 1. According to this embodiment, a part of the boil-off gas that was discarded into the atmosphere in a conventional system can be recovered as the liquefied gas. In addition, the piston 17 arranged in the single cylinder 14 can alternately pressurize the liquefied gas and the boil-off gas. Therefore, there is no need to provide a dedicated compressor for pressurizing the boil-off gas, and the installation area is not increased.

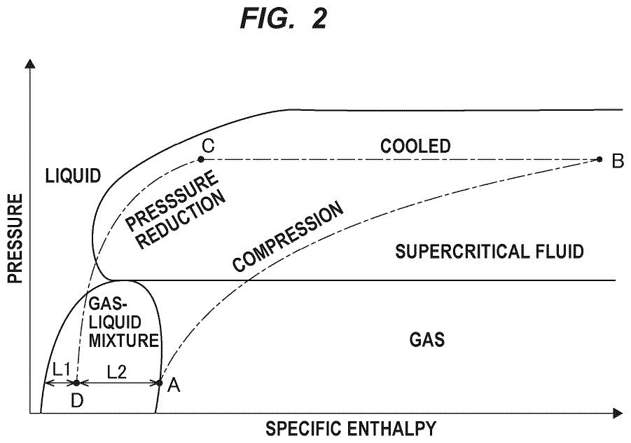

FIG. 2 is a Mollier diagram showing a state of hydrogen circulating in the liquefied-gas delivery system shown in FIG. 1. Vertical axis represents pressure of hydrogen, and horizontal axis represents specific enthalpy of hydrogen. A process from a point A to a point B in FIG. 2 is a process of compressing boil-off gas (hydrogen gas) by the reciprocating pump apparatus 3. As a result of this compression process, the boil-off gas transitions from the gas phase to a supercritical state. Hereinafter, the boil-off gas in the supercritical state is referred to as a supercritical fluid.

A process from the point B to a point C in FIG. 2 is a process of cooling the supercritical fluid by the heat exchanger 50 as the cooling device. As a result of this cooling process, the temperature of the supercritical fluid is reduced while the pressure of the supercritical fluid is maintained. A process from the point C to a point D in FIG. 2 is a process of reducing the pressure of the supercritical fluid by the pressure-reducing device 55. As a result of this pressure reducing process, the supercritical fluid becomes a gas-liquid mixture. A mass ratio of liquid hydrogen (liquefied gas) to hydrogen gas (boil-off gas) in the gas-liquid mixture corresponds to a ratio of length L2 to length L1 shown in FIG. 2.

As described above, the boil-off gas is pressurized by the piston 17 to become the supercritical fluid. The supercritical fluid can be reused by being cooled. Furthermore, the cooled supercritical fluid can be made into the gas-liquid mixture by depressurizing the cooled supercritical fluid, so that the liquefied gas can be recovered from the gas-liquid mixture.

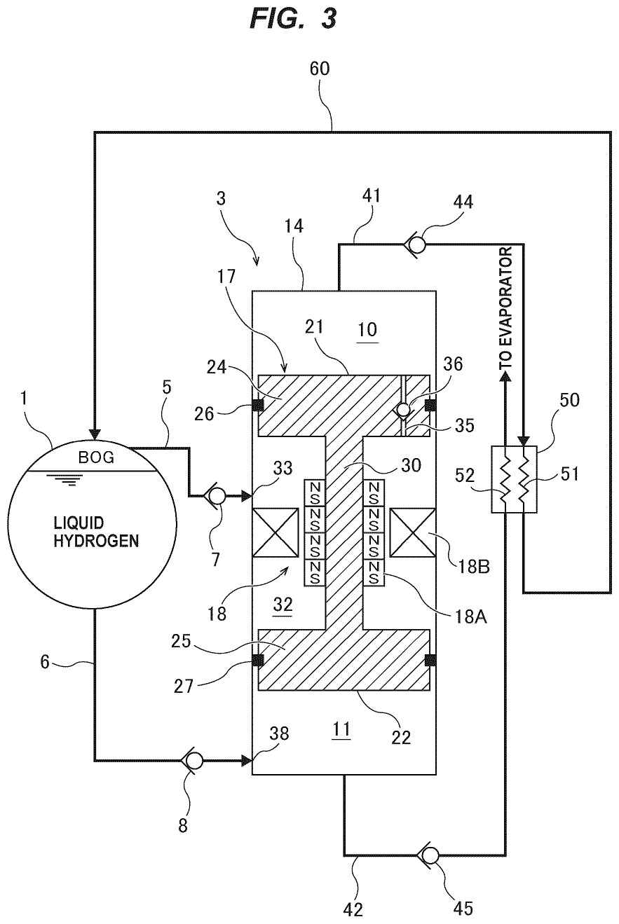

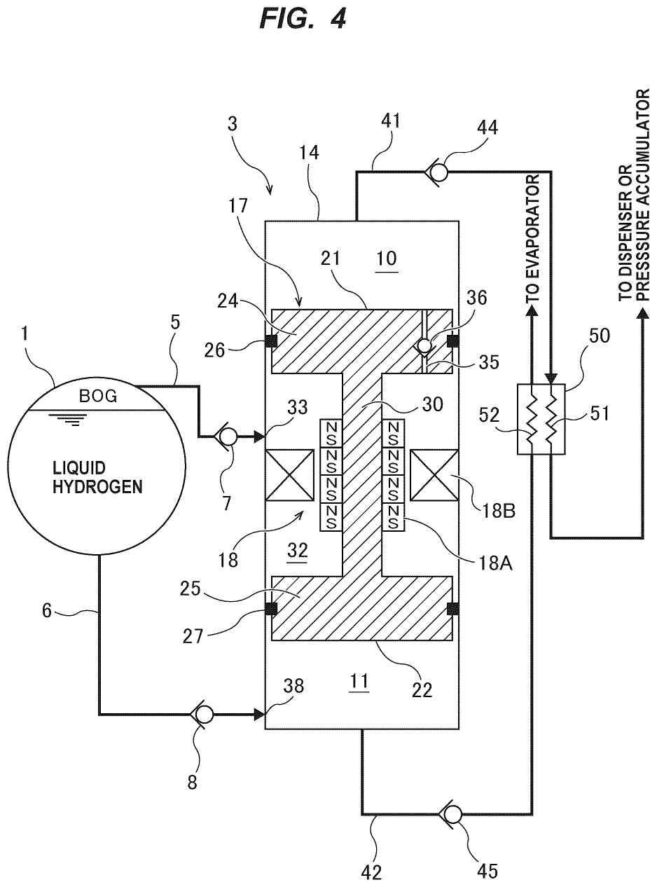

As shown in FIGS. 3 and 4, the pressure-reducing device 55 may be omitted. In the embodiment shown in FIG. 3, the boil-off gas (the supercritical fluid) that has been pressurized and cooled by the heat exchanger 50 serving as the cooling device is returned to the storage tank 1 through the return line 60, and contributes to maintaining the pressure in the storage tank 1. In the embodiment shown in FIG. 4, the boil-off gas (the supercritical fluid) pressurized and cooled by the heat exchanger 50 serving as the cooling device may be delivered to a dispenser or a pressure accumulator (e.g., the dispenser 204 or the pressure accumulator 203 shown in FIG. 10) of a hydrogen station, and is supplied to a fuel cell vehicle or the like via the dispenser.

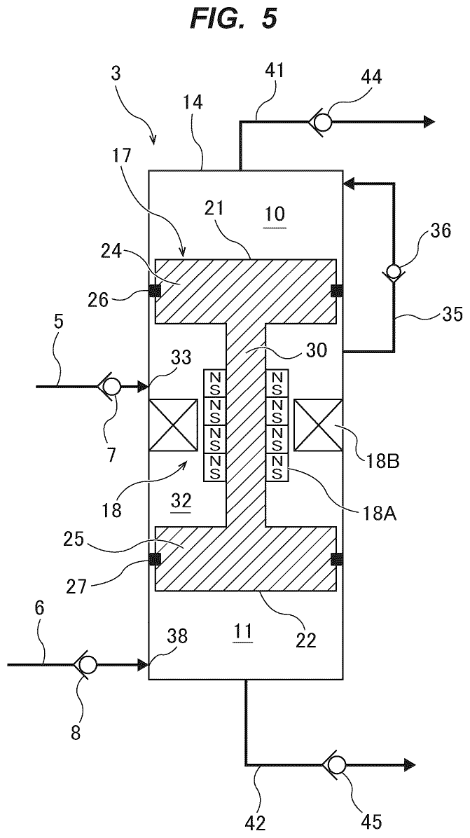

FIG. 5 is a schematic diagram showing another embodiment of the reciprocating pump apparatus 3. Configuration and operation of this embodiment that will not be particularly described are the same as those of the embodiment described with reference to FIG. 1, and overlapping description will be omitted. In the embodiment shown in FIG. 5, the communication flow passage 35 is disposed outside the cylinder 14. The check valve 36 is also disposed outside the cylinder 14. One end of the communication flow passage 35 is coupled to a wall of the cylinder 14 that forms the intermediate chamber 32, and the other end of the communication flow passage 35 is coupled to a wall of the cylinder 14 that forms the gas pressurizing chamber 10. As with the embodiment described with reference to FIG. 1, the boil-off gas in the storage tank 1 is introduced into the intermediate chamber 32 with the reciprocating movement of the piston 17, and flows through the communication flow passage 35 into the gas pressurizing chamber 10.

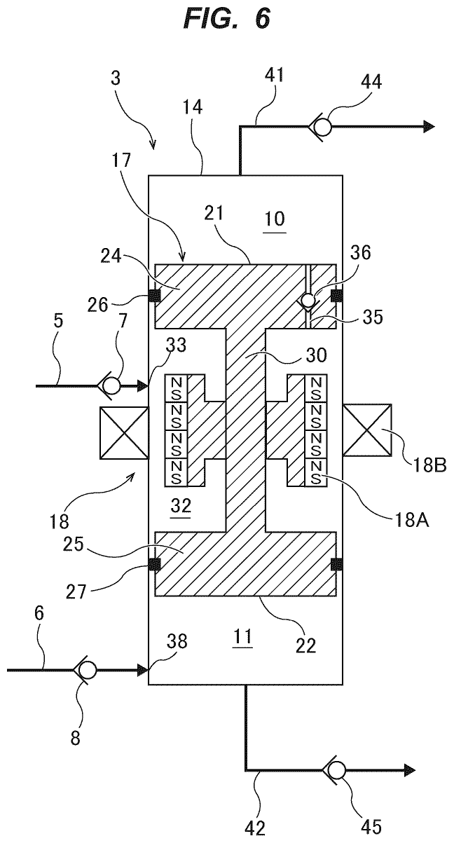

FIG. 6 is a schematic diagram showing yet another embodiment of the reciprocating pump apparatus 3. Configuration and operation of this embodiment that will not be particularly described are the same as those of the embodiment described with reference to FIG. 1, and overlapping description will be omitted. In the embodiment shown in FIG. 6, a part of the actuator 18 is disposed inside the cylinder 14, and other part is disposed outside the cylinder 14. Specifically, the actuator 18 includes permanent magnets 18A fixed to the coupling member 30 that couples the gas pressurizing piston 24 to the liquid pressurizing piston 25, and coils 18B disposed outside the cylinder 14. The permanent magnets 18A are disposed in the intermediate chamber 32 of the cylinder 14, and reciprocate together with the piston 17 and the coupling member 30. The coils 18B are located outwardly of the permanent magnets 18A.

In the embodiment shown in FIG. 6, the actuator 18 is coupled to the piston 17 at a position inside the cylinder 14. Therefore, a piston rod penetrating the cylinder 14 is not required, and a seal for closing a gap between the piston rod and the cylinder 14 is also not required. Furthermore, the boil-off gas does not leak from the gap between the piston rod and the cylinder 14.

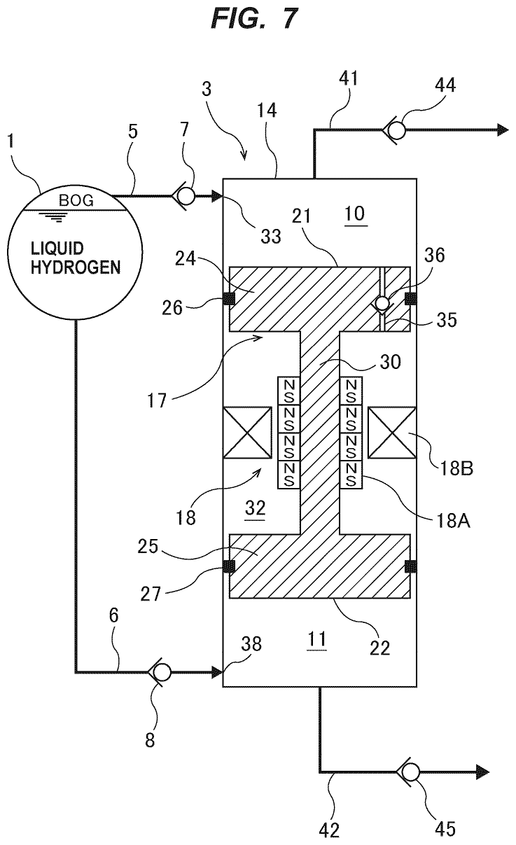

FIG. 7 is a schematic diagram showing yet another embodiment of the reciprocating pump apparatus 3. Configuration and operation of this embodiment that will not be particularly described are the same as those of the embodiment described with reference to FIG. 1, and overlapping description will be omitted. In the embodiment shown in FIG. 7, the cylinder 14 has a boil-off gas inlet 33 communicating with the gas pressurizing chamber 10. The boil-off gas inlet 33 is formed in a wall of the cylinder 14 forming the gas pressurizing chamber 10. The gas delivery line 5 is coupled to the boil-off gas inlet 33. Therefore, the boil-off gas in the storage tank 1 is directly introduced into the gas pressurizing chamber 10 through the gas delivery line 5.

In the embodiment shown in FIG. 7, the boil-off gas in the storage tank 1 is not introduced into the intermediate chamber 32, but the flow of the boil-off gas is otherwise the same as in the embodiment shown in FIG. 1. The communicating flow passage 35 and the check valve 36 are provided in the embodiment shown in FIG. 7. The communicating flow passage 35 and the check valve 36 are provided for the purpose of delivering hydrogen gas that has leaked from the liquid pressurizing chamber 11 to the gas pressurizing chamber 10 through the communicating flow passage 35.

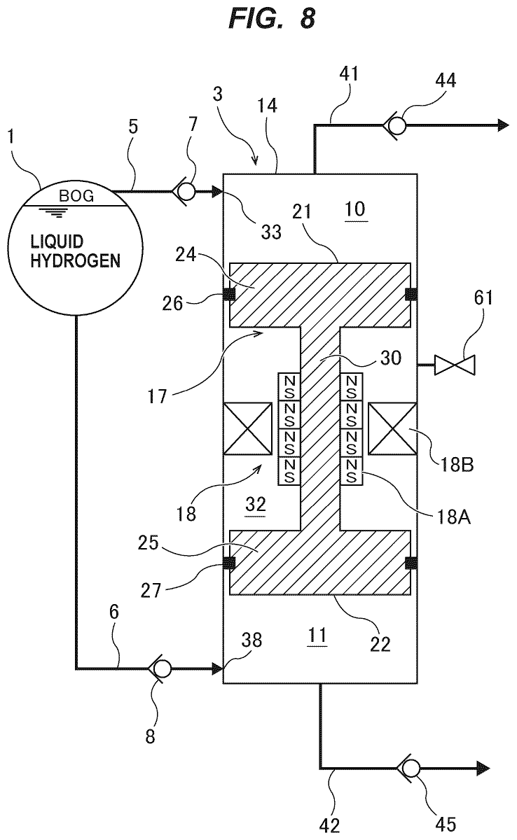

FIG. 8 is a schematic diagram showing yet another embodiment of the reciprocating pump apparatus 3. Configuration and operation of this embodiment that will not be particularly described are the same as those of the embodiment described with reference to FIG. 7, and overlapping description will be omitted. In the embodiment shown in FIG. 8, the reciprocating pump apparatus includes a relief valve 61 communicating with the intermediate chamber 32. In this embodiment, the communicating flow path 35 and the check valve 36 are not provided.

The liquid hydrogen leaking from the liquid pressurizing chamber 11 through the second seal 27 into the intermediate chamber 32 becomes the hydrogen gas, and as a result, the pressure in the intermediate chamber 32 increases. The relief valve 61 is configured to open when the pressure in the intermediate chamber 32 exceeds a set value, and to release the hydrogen gas in the intermediate chamber 32 to the outside of the cylinder 14.

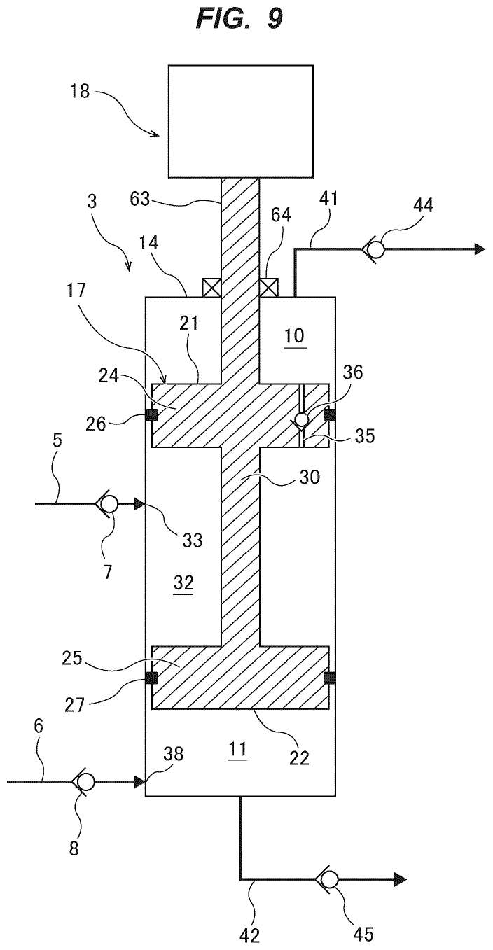

FIG. 9 is a schematic diagram showing yet another embodiment of the reciprocating pump apparatus 3. Configuration and operation of this embodiment that will not be particularly described are the same as those of the embodiment described with reference to FIG. 1, and overlapping description will be omitted. In the embodiment shown in FIG. 9, the actuator 18 is disposed outside the cylinder 14. The piston 17 is coupled to the actuator 18 by a piston rod 63 that passes through the cylinder 14. The reciprocating pump apparatus 3 includes a seal 64 that seals a gap between the piston rod and the cylinder 14.

The reciprocating pump apparatus 3 of this embodiment is applicable to cases where a slight amount of boil-off gas leakage from the cylinder 14 is permitted.

The embodiments described with reference to FIGS. 1 to 9 may be appropriately combined. For example, any of the embodiments described with reference to FIGS. 5 to 9 may be applied to the embodiment described with reference to FIG. 3 or FIG. 4.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention can be used in a liquefied-gas delivery system including a pump apparatus for pumping liquefied gas and boil-off gas.

### REFERENCE SIGNS LIST

1 storage tank
3 reciprocating pump apparatus
5 gas delivery line
6 liquid delivery line
7 gas check valve
8 liquid check valve
10 gas pressurizing chamber
11 liquid pressurizing chamber
14 cylinder
17 piston
18 actuator
18A permanent magnet
18B coil
21 gas pressurizing surface
22 liquid pressurizing surface
24 gas pressurizing piston
25 liquid pressurizing piston
26 first seal
27 second seal
30 coupling member
32 intermediate chamber
33 boil-off gas inlet
35 communicating flow passage
36 check valve
38 liquefied-gas inlet
41 first discharge line
42 second discharge line
44 first discharge-side check valve
45 second discharge-side check valve
50 heat exchanger (cooling device)
51 heating flow path
52 cooling flow path
55 pressure-reducing device
60 return line
61 relief valve
63 piston rod
64 seal
200 storage tank
201 pump
202 evaporator
203 pressure accumulator
204 dispenser

What is claimed is:

1. A liquefied-gas delivery system for delivering liquefied gas in a storage tank, comprising:
a reciprocating pump apparatus configured to pressurize the liquefied gas and boil-off gas in the storage tank,
the reciprocating pump apparatus including:
a cylinder having a gas pressurization chamber and a liquid pressurization chamber therein;
a piston disposed in the cylinder; and
an actuator coupled to the piston and configured to reciprocate the piston,
wherein the piston is located between the gas pressurization chamber and the liquid pressurization chamber, and
the piston has a gas pressurization surface facing the gas pressurization chamber and a liquid pressurization surface facing the liquid pressurization chamber.

2. The liquefied-gas delivery system according to claim 1, wherein the piston comprises a gas pressurizing piston having the gas pressurizing surface, and a liquid pressurizing piston having the liquid pressurizing surface,
the reciprocating pump apparatus further comprises:
a coupling member that couples the gas pressurizing piston to the liquid pressurizing piston and allows the gas pressurizing piston and the liquid pressurizing piston to reciprocate together; and
an intermediate chamber located between the gas pressurizing piston and the liquid pressurizing piston and is located within the cylinder.

3. The liquefied-gas delivery system according to claim 2, wherein the reciprocating pump apparatus further comprises:
a communication flow passage that provides a fluid communication between the intermediate chamber and the gas pressurization chamber; and
a check valve disposed in the communication flow passage, the check valve being configured to allow a one-way flow from the intermediate chamber to the gas pressurization chamber.

4. The liquefied-gas delivery system according to claim 3, wherein the cylinder has a boil-off gas inlet communicating with the intermediate chamber.

5. The liquefied-gas delivery system according to claim 3, wherein the communication flow passage extends through the gas pressurizing piston.

6. The liquefied-gas delivery system according to claim 3, wherein the communication flow passage is disposed outside the cylinder.

7. The liquefied-gas delivery system according to claim 1, wherein the cylinder has a boil-off gas inlet communicating with the gas pressurizing chamber.

8. The liquefied-gas delivery system according to claim 1, wherein at least a part of the actuator is disposed within the cylinder.

9. The liquefied-gas delivery system according to claim 8, wherein a position at which the actuator is coupled to the piston is located within the cylinder.

10. The liquefied-gas delivery system according to claim 2, wherein the reciprocating pump apparatus further comprises a relief valve communicating with the intermediate chamber.

11. The liquefied-gas delivery system according to claim 1, further comprising:
a first discharge line coupled to the gas pressurization chamber;
a second discharge line coupled to the liquid pressurization chamber; and
a cooling device coupled to the first discharge line.

12. The liquefied-gas delivery system according to claim 11, wherein the cooling device is a heat exchanger having a heating flow path and a cooling flow path adjacent to each other, the heating flow path being coupled to the first discharge line, and the cooling flow path being coupled to the second discharge line.

13. The liquefied-gas delivery system according to claim 11, further comprising a pressure-reducing device coupled to the first discharge line and disposed downstream of the cooling device.

14. The liquefied-gas delivery system according to claim 13, further comprising a return line extending from the pressure-reducing device to the storage tank.
